(19) United States
(12) Patent Application Publication
(10) Pub. No.: US 2009/0054096 A1
(43) Pub. Date: Feb. 26, 2009

(54) Low power range and position determination for wireless communication nodes

(75) Inventor: Peter S. Single, NSW (AU)

Correspondence Address: BSTZ/G2 MICROSYSTEMS, INC., 12400 Wilshire Boulevard, Seventh Floor, Los Angeles, CA, 90025-1030, US

(73) Assignee: G2 Microsystems Pty. Ltd.

(21) Appl. No.: 11/894,462

(22) Filed: Aug. 20, 2007

(51) Int. Cl. H04Q 7/20

(52) U.S. Cl. 455/509

(57) ABSTRACT

Range to a wireless communications node and position relative to one or more wireless communication nodes can be determined with a reduced amount of power consumption. In one example, a probe request is sent at a first power level. Probe responses in response to the probe request are listened for. The number of different radios from which a probe response has been received is counted and compared to a threshold. If the count does not exceed the threshold, then a second different probe request is sent.

### BACKGROUND

1. Field

The present description pertains to the field of finding the range and position of wireless communication nodes for use by mobile nodes, such as radio frequency identification (RFID) tags and, in particular, to selecting an access point using low energy.

2. Related Art

Portable tags are becoming increasingly popular for tracking and managing inventories and production processes. A tag is attached to a carton, container, pallet or any other article. In a factory, the tag can be attached to a carrier for the item being produced or attached to the actual item if that item is large enough, such as an automobile. The tag can be tracked and located as it is moved around and this allows the position and accurate inventory records for the article to be maintained.

Active radio frequency identification tags, occasionally send out radio messages that allow their position to be determined and reported. The nature of the message depends upon the particular tag. In one common scenario, radio access points (AP) are located throughout a building or plant. When the tag transmits, it first tries to find one of these access points. It can then send an identification number and perhaps some location, condition, and status information to the access point. The location might be determined by the tag. It might be determined by the access point, or it might be determined using several access points.

When a tag begins a communication cycle, it can try to communicate with the access point to which it was last connected, however, when an RFID (Radio Frequency Identification) tag is used to determine and report the location of a movable asset, it is entirely possible that the asset has been moved since the last communication attempt and the RFID tag has been moved along with it. Upon waking or entering a new communication cycle, the last access point may no longer be available. The entire environment of surrounding access points may be completely different from the last communication attempt.

Communication protocols, such as IEEE 802.11 (a standard for wireless communications promulgated by the Institute of Electrical and Electronics Engineers) provide a protocol that the tag can use to discover the access points that are within range. The tag can then select an appropriate access point using any approach that may be suitable. One approach is to select the access point with the highest RSSI (Received Signal Strength Indication). In many cases, this access point will be the closest and have the clearest signal.

If there are a large number of nearby access points, that is the access point density is high, selecting the best access point, using any approach, can be time consuming. In a typical 802.11 protocol, the tag sends out a probe using its transmitter. The probe is received by all of the access points within range. Each access point can then decide whether to respond. Normally all of the access points will respond. The tag waits while all access points within range respond. According to the 802.11 protocol, the tag must then acknowledge each response. Normally, there are three or more different radio channels that an access point can use, so the tag repeats this process on each channel. This allows the best access point and the best channel to be discovered.

The interval between each probe response received by the tag is typically 1 ms (millisecond), so if the tag can “see” a large number of access points (e.g. 30 per channel), then the tag must spend approximately 30 ms (1 ms×30 AP's) transmitting and receiving messages for each channel. Usually the tag will repeat this process for each of the three channels. In addition, in order to obtain a reliable indication of an access point's RSSI, multiple RSSI measurements are normally needed for each channel (e.g. 3), so the tag might be transmitting or receiving for almost 2 seconds for each location (1 ms×30 APs×3 channels×3 measurements). This is before the AP can determine the position of the tag or transmit any information about its position to an outside tracking system.

Each millisecond that the tag must stay active consumes energy The transmitter uses even more power than the receiver, the processor and the memories. Many RFID tags are battery-powered and the process of selecting an access point can consume significant battery power. This is particularly true if the tag must repeat this process each time that it has to report its position. This power consumption will eventually discharge a tag's battery. However, a longer battery life will significantly reduce the cost of using and maintaining a large number of RFID tags.

### SUMMARY

Range to a wireless communications node and position relative to one or more wireless communication nodes can be determined with a reduced amount of power consumption. In one example, a probe request is sent at a first power level. Probe responses in response to the probe request are listened for. The number of different radios from which a probe response has been received is counted and compared to a threshold. If the count does not exceed the threshold, then a second different probe request is sent.

### BRIEF DESCRIPTION OF THE DRAWINGS

The invention may be more fully appreciated in connection with the following detailed description taken in conjunction with the accompanying drawings, in which like reference numerals refer to corresponding parts throughout the several views of the drawings, and in which:

FIG. 1 is a block diagram of an identification tag in an environment including multiple access points for communication, according to an embodiment of the invention;

FIG. 2 is a process flow diagram of establishing communications with one of the access points, according to an embodiment of the invention;

FIG. 3 is a block diagram of a radio frequency identification tag, according to an embodiment of the invention.

### DETAILED DESCRIPTION OF THE INVENTION

In a typical RSSI (Received Signal Strength Indicator) location system, the best location data is obtained from APs (Access Points) that are close to the tag. These tags also typically have the clearest signal and provide the highest signal strength. They also typically require the least amount of transmit power from the tag. The signal amplitude received by the tag drops by about 6 dB every time the distance between a tag and an AP doubles. As a result, it is easier to get accurate distance measurements from APs that are close to a tag. These are then the best APs to use to determine location. When there are many APs present, responses from distant APs can therefore be discarded.

In one example of the invention, an active RFID tag determines which APs to communicate with by sending out polls at progressively higher power levels, until it has received responses from enough APs. The APs that responded to the lowest power polls are selected for communication. The selection is improved by sending several polls to a candidate group of APs and then picking the one or ones with the highest power response. If the APs all have about the same transmit power, then the APs with the highest receive power will be the closest or the ones with the best path.

The choice of APs becomes even more important, if the APs are to be used by the tag to determine its location. In some systems, the tag determines its location by selecting what appears to be the closest AP. Its location is then determined as being near that AP. In other systems, several APs listen to signals from the tag and, using triangulation or some other approach determine the position of the tag. The tag has no participation in this process.

In another scenario, however, the tag determines its position by listening to signals from the APs. There are several different methodologies, but they typically rely on signal strength or the time from transmission to receipt. These approaches are more accurate, the closer the tag is to the AP, so by choosing the closest APs, the tag will have a more accurate position determination. Probe responses from distant APs contribute little to the tag accurately determining its position. This is because the signal amplitude, or RSSI, received by the tag changes less with location the further away the tag is from the AP.

Another advantage of communicating with closer tags is power savings. If there is a transmit power control protocol, the tag can use less power to transmit to closer tags, extending the life of the tag. However, the greatest power savings benefit comes from reducing the number of APs with which the tag must communicate.

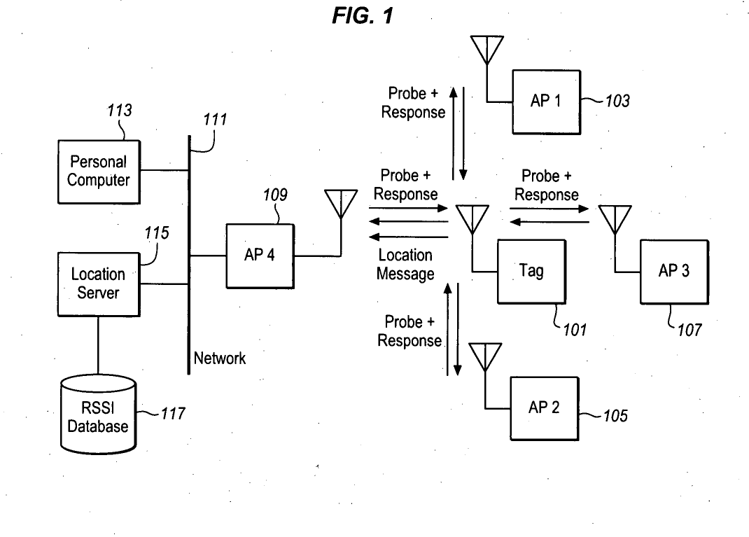

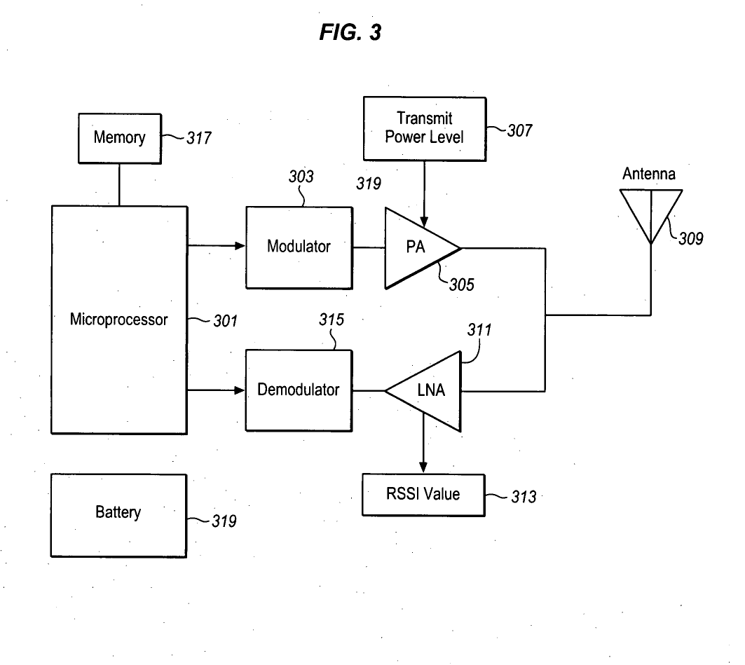

FIG. 1 is a block diagram of an example environment for a location tag. It also shows some messages that are passed between the tag and the APs. In FIG. 1, there is a single tag 101. As mentioned above, this is typically attached to some article that is to be tracked or to a carrier of that article. The carrier could be a sled, a rack, a pallet, a container, a trailer or any of a variety of other carriers. The tag has an integral antenna that it uses to send and receive information. The tag is described in more detail in the context of FIG. 3. In the described example, the tag is a battery powered active tag capable of sending, receiving, and processing. The particular configuration of the tag is not important to the invention. Instead of a tag, a more complex device can be used that performs other functions beyond those described here. The tag can be one that is capable of determining its position, or one that relies on the APs for position determinations.

FIG. 1 also shows four APs 103, 105, 107, 109. As shown in FIG. 3, each AP receives a probe from the tag and sends a response back to the tag. The particular format of the probe and response is not important to the invention. A wide range of different techniques may be used. The examples described herein are based on 802.11 protocols, but any other signaling system may be used. The APs may be conventional wireless access points used in personal computer networking, or they may be specifically adapted to this or a variety of other applications.

One of the APs, AP4 109 also receives a location message. This indicates that the tag has selected this AP as the one with which to communicate. The selection can be done using the approach described below or any number of other approaches. The location message may contain nothing more than an identification of the tag. This permits the AP to attach a location and a time to the tag identity so that it can be tracked. Additional information may also be added depending on the particular application. The message may also include other information, including a location determined by the tag, environmental measurements by the tag, logged data that the tag has accumulated since its last message or since any other point in time, and more. The content and the configuration of the message can be selected to suit the particular articles being tracked and the environment in which they are being tracked.

AP4 is also shown as being connected through a network 111 to a personal computer 113 and a location server 115. The other APs are also connected to the network, either directly, like AP4 or through other APs. These connections are not shown in order to simplify the drawing. The personal computer may be used to track the locations of each of the tagged articles and also to make configuration and other changes. The personal computer or user terminal provides access to the APs and the network for configuration, maintenance, management or any other purpose.

The location server determines the location of each tag. It usually stores a location map of each access point, or alternately it can store a map of RSSI values and the places where these RSSI values may be found. The location server also maintains a record of the location of each of the tags that report into an AP. This record may be sent to an inventory maintenance and tracking system, a delivery fulfillment system, a customer location system or any of a variety of other systems. As an alternative, the location system can determine the location of the tag. It may do this based on determinations from the APs or it may receive only measurements from the APs.

In one example, the location server receives RSSI measurements from each AP that detects the probe or another signal from the tag. The location server 115, is coupled to an RSSI database 117. This database has a table of RSSI values for each AP. Using the table and the measurements from the AP, the location server can determine the location of the AP. This value can be stored in the location server, and, as mentioned above, sent to other devices that desire the information.

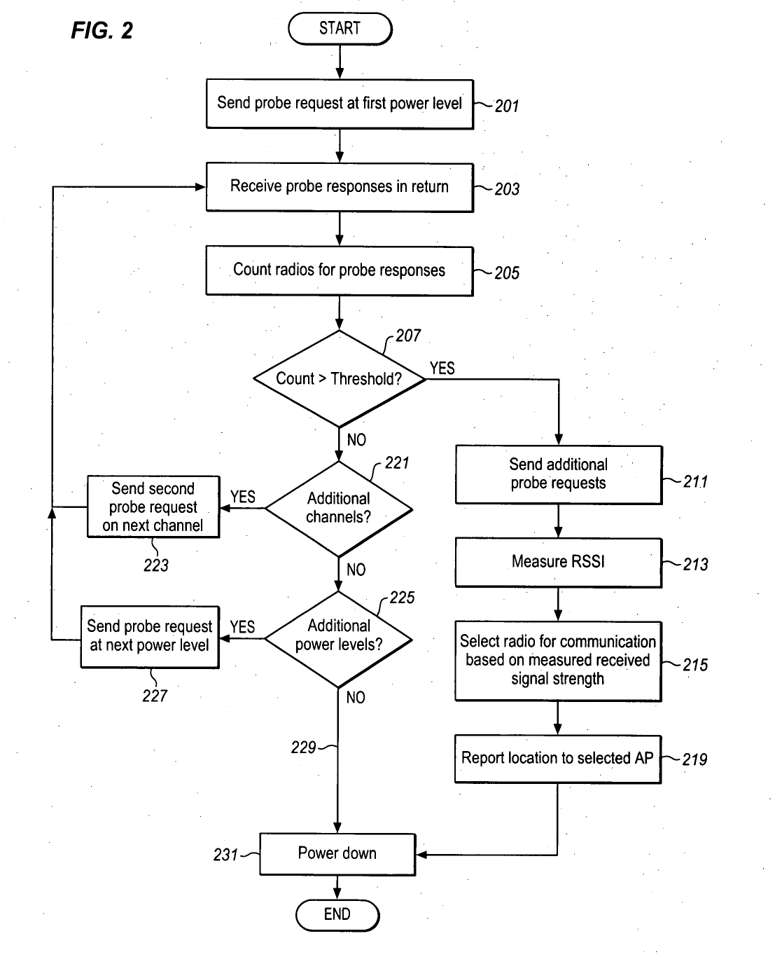

FIG. 2 shows a process for selecting an AP in more detail. In the example of FIG. 1, AP4 was selected but the best choice will depend upon the circumstances and the position of the tag. In one example, the transmitted amplitude of probe requests sent by the tag is varied. The variations are based on the number of responses received. When sending probe requests, the tag can use a process like this.

First, the tag transmits a probe response at a low transmit power, such as 0 dBm. The tag can transmit a standard 802.11 probe or some other protocol may be used. Access points that receive that probe respond with a standard probe request, which the tag must acknowledge. Only APs that are close to the tag will receive enough energy to decode the probe and to respond. Assume for this example that a single AP responds.

Second, with only one response, the tag then transmits a second probe at higher energy, such as +6 dBm. Assume for the this example that 4 APs respond. The tag can then compare the number of responses (4) to a predetermined minimum limit (say 3), and decides that +6 dBm is an adequate power level. Since the number of responses 4 is more than 3, the tag has found enough tags and will not transmit at a higher level. On the other hand, if only 2 APs have responded, the tag would send another higher power probe at, for example +12 dBm.

The tag can then transmit two more probes at +6 dBm. These are done to provoke the 4 APs to send responses. The tag can measure the RSSI data for these responses and then use that to select the best tag and also for location determination.

The tag can repeat this algorithm on all three channels, starting from the lowest, such as 0 dBm, transmit power each time. In one example, the tag sends probes on all three channels at each power level before moving on to the next power level. In another implementation, the tag may send the probe response at three or four power levels on one channel and accumulate the results before moving on to the next channel.

After all of the channels have been checked, the tag accumulates the RSSI measurements for each probe response. These are then passed to the AP, AP4 in FIG. 1, to then pass it to location server. The location server compares the amplitude values obtained by the tag with previous measurements and, using the RSSI database, determines the location of the tag.

This kind of process is shown for example in FIG. 2. In the example of FIG. 2 after the start, the process moves to block 201 at which the tag sends a probe request at the first power level. As a result, at block 203, the tag receives probe responses in return. This protocol and the names of the messages and even the number of channels are based on the example of using 802.11, but other types of signals can be used depending on the particular protocol that is being employed. The 802.11 protocol requires the tag to acknowledge all the probe responses. This is not shown in FIG. 2 and this operation may be skipped at least for those APs which are not selected.

At block 205, the tag counts the radios from which it received probe responses. This count is compared to some threshold number at block 207. In many cases, three or four APs will be sufficient for both reporting and for location determination. In some applications, a single AP will suffice, while in other applications, the threshold is set much higher.

If the count is greater than the threshold, then at block 211 additional probe requests are sent at the first power level. These probe requests are used in order to make RSSI measurements of the returned probe responses at block 213. The RSSI measurement are then used, at block 215, to select a radio, for example an AP, for communication to the network. Typically, the radio with the highest RSSI will be selected. This will represent the closest radio, or at least the radio with the best signal path.

Other measurements may be used for this selection, such as carrier to interference ratios, bit error rates, propagation time delay or any other measurement of the quality of the radio channel or the distance between the tag and the AP. Typically the closest AP or the one with the best channel is selected. If a single best channel cannot be identified, then the tag can select any AP in the highest scoring group. An additional algorithm may be used to select an AP in the case of a tie. One example is to pick based on the identifier provided by the tag. Another example is to pick the one that is received first. Other algorithms may also be used depending on the particular application. The choice may also be completely or partially arbitrary or random.

After one of the APs has been selected, then in block 219, the location message is sent to the selected AP. The tag can first acknowledge the probe response. This may be necessary or optional depending upon the particular wireless protocol. The nature of this message will depend on the particular implementation. This message can include all of the RSSI measurements or propagation delay measurements that the tag has made. As mentioned above, the location server can use this information to determine the position of the tag. The location can alternatively include other information that the tag has been programmed with or that it has collected and that is appropriate to report in the particular situation. The location message can also include a location determination that the tag has made.

After the report has been made the tag will power down at block 231 and the process ends. The process starts again based on a timer, an environmental sensor, a signal received from an access point or other trigger or from any other device.

It can also happen that the number of responding APs is less than the threshold. In this case, the tag will try additional channels and additional power levels until it has received enough responses. In the example of FIG. 2, each channel is tried before the AP goes to the next power level. This results in less power being used but it may take longer to find enough access points. The number of available channels will depend on the configuration of the wireless communication system. In the example of FIG. 2, at block 221, the tag determines whether there are any more channels at the current power level. If there are, then at block 223, the tag sends a probe request at the same power on another channel. Then the process returns to block 203. As described above, from block 203, the tag receives responses, counts them compares them to the threshold and so forth.

If there are still not enough APs responding, then the tag again determines if there are any more channels at the current power level at block 221. If there are no more channels, then at block 225, the tag determines whether there are any additional power levels. The number of available power levels can be determined based on the performance limitations of the tag's transmitter and the size of the steps. As an alternative, in order to save battery power, the total transmit power can be limited to below the maximum that the transmitter can do. If the tag identifies an AP that requires a high level of transmit power, this could present an excessive drain on the battery. The tag can be set to try again later to see if a closer AP is available. This can happen if the tag is moved or if a previously occupied AP is later free to communicate with the tag. The tag can also have an internal decision process that measures the charge level of the battery and if the battery has a high charge level, then high transmit power levels are allowed, whereas when the charge level is low, then only lower transmit power levels are allowed.

If there are no additional power levels, then the tag goes to block 231 and the process ends. On the other hand, if there are additional power levels, then the tag sends a probe request at the next higher power level at block 227. The process then returns to block 203 so that responses are received and counted and if there are enough, then an AP is selected. This is repeated again for each channel at that power level. When the power levels and the channel levels are exhausted, then at block 229 the process ends.

There may also be additional operations performed, after a suitable AP has been selected. FIG. 2 only shows reporting location at block 219, however many other operations may be performed. The tag may receive location, condition, status or other data from the AP to store and report when it arrives at another location. The tag may report environmental conditions that it has measured to the AP. There may be status or software updates, from the AP and more.

In the example of FIG. 2, the threshold comparison is made for each channel separately. In other words, if there are not enough APs on any one channel, then the tag moves on to the next channel or the next power level. This is not necessary to the invention. The count of APs may be accumulated over some or all of the available channels and then the cumulative total may be compared to the threshold. However, as previously mentioned, close APs provide better location information than distant ones, so location will be determined most accurately if the closest APs are employed.

Accordingly, in one embodiment, all of the APs available on all available channels are identified at each power level. At the power level for which the threshold is first exceeded, all of the APs and channels at that power level will be used to determine location and to select the best AP and channel for communication.

Alternatively, the threshold and the comparison may be eliminated entirely. If the tag does not report measurements from multiple APs, then it only needs to find one AP. The AP that it finds at the lowest power is sufficient for it to send its location message.

As mentioned above, after the tag sends its location message, this may be stored in or acknowledged by the location server and used for many different purposes. The information, for example may be reported for inventory tracking, for delivery tracing, and for many other purposes. It may also be made available to other entities, either through access to the database, a data feed to an external recipient or in many other ways.

FIG. 3 shows an example of a tag that may be used for the tag 101 of FIG. 1. The tag has a controller, or microprocessor 301 to manage the transmit and receive operations described above. The controller is coupled to a modulator 303 to modulate any data that the controller is to send. The modulated data is sent to a power amplifier 305 that sends the modulated signal to an antenna 309. The amplifier controls the power used to send the signals and provides the various power levels mentioned above.

In addition to the transmit chain, the tag also has a receive chain that includes a low noise amplifier 311 coupled to the antenna to amplify any received signals that come through the antenna 309. The amplifier is coupled to a demodulator 315 that provides the demodulated data to the controller. The transmit and receive chains may also include additional components, such as oscillators, mixers, up and down converters and other components as may be desired for a particular radio frequency, modulation, and encoding scheme.

The receive chain also has an amplitude detector 313 to determine the received signal strength of the received signals. The determined values are used for the AP selection and location determination as described above. Alternatively, or in addition, other aspects of the signals may be measured and provided to the controller, these include carrier, interference, and noise levels, error rates, timing and other measures. The particular construction of the devices for making these measurements may be adapted to suit the particular radio environment and the types of signals to be measured.

The controller is coupled also to a transmit power controller 307, the amplitude detector 313 and can additionally be coupled to any of the other components to receive or provide data and to provide control over the overall system. These connections are not shown. Instead the connections are shown only to illustrate the path of incoming and outgoing messages. In the example of FIG. 3, the controller generates and interprets messages, counts the responses, counts the number of responses, makes comparisons and performs similar operations as described above.

The controller is further coupled to memory, the memory includes non-volatile memory, such as ROM (Read Only Memory) for program instruction and identification values. The memory also includes writeable registers for storing measurements, operands, AP identifications and other values. The memory 317 shown in FIG. 3 is coupled to the controller and includes both types. This memory can instead be included within the controller depending on the circumstances.

FIG. 3 further shows a battery 319 for powering all of the components. The battery may be a conventional chemical cell, a photovoltaic cell, or any other type of power supply or combination of different types of power supplies. As mentioned above, in many applications, the tag is supplied with a single battery and it has a limited amount of total power available. Accordingly, by reducing the transmit power of the tag as described above, the life of the battery can be extended.

Nevertheless the invention and its usefulness are not limited to battery-powered tags or tags that require power conservation. Even if power conservation is not important, the operations described above allow a tag to choose a better AP and to minimize the total RF energy around the tag. This allows for more accurate communication and it allows for more accurate position determinations in many cases. As mentioned above, when position is to be determined based on receiving signals from multiple APs, the signals from closer APs provide better location determinations than those from more distant APs. The operation described above more accordingly be used for faster, more accurate, and more secure communications and location determinations.

The approaches described herein may be used in any situation in which a mobile node is to select from among multiple other nodes, whether fixed or mobile, for wireless communication. For example, the approaches may be used when a single node is introduced into a new environment, when nodes, whether fixed or mobile, are added to or removed from an existing environment and when multiple mobile nodes seek to establish ad-hoc networks.

A lesser or more equipped transmitter or receiver than the examples described above may be preferred for certain implementations. Therefore, the configuration of the exemplary tag in FIG. 3 or the environment in FIG. 1 will vary from implementation to implementation depending upon numerous factors, such as price constraints, performance requirements, technological improvements, or other circumstances. The particular nature of any attached devices may be adapted to the intended use of the device. Any one or more of the devices, interfaces, or interconnects may be eliminated from this system and others may be added. For example, a variety of different connections to the access point may be provided based on different wired or wireless protocols. In addition, the particular configuration and frequencies of the magnetic coils may be adapted to suit different applications.

In the description above, for purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various steps. The steps of the present invention may be performed by hardware components, such as those shown in the Figures, or may be embodied in machine-executable instructions, which may be used to cause general-purpose or special-purpose processor or logic circuits programmed with the instructions to perform the steps. Alternatively, the steps may be performed by a combination of hardware and software.

The present invention may be provided as a computer program product which may include a machine-readable medium having stored thereon instructions which may be used to program an agent or a computer system to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of machine-readable media suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods and apparatus are described in their most basic form but steps may be added to or deleted from any of the methods and components may be added or subtracted from any of the described apparatus without departing from the basic scope of the present invention. It will be apparent to those skilled in the art that many further modifications and adaptations may be made. The particular embodiments are not provided to limit the invention but to illustrate it. The scope of the present invention is not to be determined by the specific examples provided above but only by the claims below.

1. A method comprising:
sending a probe request at a first power level;
listening for probe responses in response to the probe request;
counting the number of different radios from which a probe response has been received;
comparing the count to a threshold;
sending a second different probe request, if the count does not exceed the threshold.

2. The method of claim 1, wherein sending a second probe request comprises sending the second probe request at a second higher power level.

3. The method of claim 1, wherein sending a second probe request comprises sending the second probe request at the first power level on a different channel.

4. The method of claim 1, further comprising sending additional probe requests at the first power level, if the count exceeds the threshold.

5. The method of claim 1, further comprising:
measuring the received signal strength of the received probe responses; and
selecting a radio for communication based on the measured received signal strength.

6. The method of claim 2, wherein selecting a radio comprises sending the measured received signal strengths to a remote device and receiving a designation of the radio for communication.

7. The method of claim 2, further comprising acknowledging the probe response from the selected radio.

8. The method of claim 1, wherein the second probe request is at a higher power level, the method further comprising:
listening for probe responses in response to the second probe request;
counting the number of different radios from which a probe response has been received from the second probe request to obtain a second count;
comparing the second count to the threshold; and
sending a third probe request at a third higher power level, if the second count does not exceed the threshold.

9. The method of claim 1, wherein the second probe request is at the first power level and on a different channel, the method further comprising:
listening for probe responses in response to the second channel probe request;
counting the number of different radios from which a probe response has been received from the second channel probe request to obtain a second channel count; and
comparing the count to the threshold.

10. A machine-readable medium containing instructions which when executed by the machine cause the machine to perform operations comprising:
sending a probe request on a first channel from an omnidirectional antenna;
listening for probe responses in response to the probe request;
counting the number of different radios from which a probe response has been received;
comparing the count to a threshold;
sending a second probe request on another channel if the count does not exceed the threshold.

11. The medium of claim 10, wherein the instructions further cause operations comprising:
listening for probe responses in response to the second probe request;
counting the number of different radios from which a probe response has been received from the second probe request to obtain a second count;
comparing the second count to the threshold; and
sending a third probe request on another channel, if the second count does not exceed the threshold.

12. The medium of claim 11, wherein the second probe request is at the same power level as the first probe request and wherein the instructions further cause operations comprising:
listening for probe responses in response to the third channel probe request;
counting the number of different radios from which a probe response has been received from the third channel probe request to obtain a third channel count;
comparing the count to the threshold;
determining whether additional channels are available; and
if no additional channels are available, then sending a probe request at a higher power level.

13. The medium of claim 10, wherein the instructions further cause operations comprising sending additional probe requests at the first power level, if the count exceeds the threshold.

14. The medium of claim 13, wherein the instructions further cause operations comprising:
measuring the received signal strength of the received probe responses; and
selecting a radio for communication based on the measured received signal strength.

15. The medium of claim 14, wherein selecting a radio comprises sending the measured received signal strengths to a remote device and receiving a designation of the radio for communication.

16. An apparatus comprising:
a transmitter to send a probe request at a first power level;
a receiver to listen for probe responses in response to the probe request;
a processor to count the number of different radios from which a probe response has been received, to compare the count to a threshold, and to determine whether to send a second probe request at a second higher power, or to send additional probe requests at the first power level, depending on whether the count exceeds the threshold.

17. The apparatus of claim 16, wherein the transmitter further sends additional probe requests on additional channels at the first power level if the count exceeds the threshold.

18. The apparatus of claim 17, further comprising a signal strength detector and wherein the processor further selects a radio from among the radios from which a probe response has been received for communication based on information from the signal strength detector.

19. The apparatus of claim 17, further comprising a signal strength detector to measure the signal strength of received probe responses for use in determining the location of the apparatus.
